(19) United States
(12) Patent Application Publication
(10) Pub. No.: US 2013/0044180 A1
(43) Pub. Date: Feb. 21, 2013

(54) STEREOSCOPIC TELECONFERENCING TECHNIQUES

(71) Applicant: Peter Shintani, San Diego, CA (US)

(72) Inventor: Peter Shintani, San Diego, CA (US)

(73) Assignee: SONY CORPORATION, Tokyo (JP)

(21) Appl. No.: 13/211,295

(22) Filed: Aug. 16, 2011

(51) Int. Cl. H04N 7/15; H04N 13/04; H04N 13/02

(52) U.S. Cl. 348/14.07; 348/46; 348/56; 348/E13.074; 348/E13.026; 348/E07.083

(57) ABSTRACT

Stereoscopic teleconferencing techniques described herein are directed toward systems including a plurality of telecommunication stations. A first telecommunication station includes a stereoscopic camera, a pair of shutter glasses, and a first processing unit. A second telecommunication station includes a display, a pair of shutter glasses, and a processing unit. The stereoscopic camera of the first telecommunication station generates a set of stereoscopic images including one or more users. The processing unit of the first telecommunication station determines a location of the shutter glasses in the sets of stereoscopic images and replaces the image of the shutter glasses with the corresponding portion of the given user's face to generate modified sets of stereoscopic images. The display of the second telecommunication station outputs the modified sets of stereoscopic images. The processing unit of the second telecommunication station controls the shutter glasses of the second telecommunication station to present a left eye and a right eye view of the modified sets of stereoscopic images output on the display to a user of the second telecommunication station. Accordingly, the users appear as if they are not wearing shutter glasses in the modified sets of stereoscopic images output on the display.

### BACKGROUND OF THE INVENTION

In the past, televisions, teleconferencing systems, and the like output two-dimensional projections. More recently, televisions, teleconferencing systems, and the like have expanded to output three-dimensional (3D) projections.

Three-dimensional televisions, 3D teleconferencing systems, and the like produce a left eye and right eye two-dimensional projection 110, 120 of an image, as illustrated in FIG. 1. Typically the images are captured by a camera including a pair of image sensors spaced apart from each other the approximate distance between a person's eyes. The left and right eye views 110, 120 from the cameras are then presented sequentially on a display device. Shutter glasses 130 are used to present the left and right eye views independently to each respective eye of the user. The resulting non-auto stereoscopic image 140 appears to have depth in front of and behind the display device when used in combination with shutter glasses 130.

The appearance of users wearing shutter glasses is generally not a significant concern for merely viewing 3D content such as movies and television shows on a display. However, the appearance of the shutter glasses 130 can be awkward and/or distracting during 3D teleconferencing as illustrated in FIG. 1. Therefore, there is a continuing need for improved non-auto stereoscopic techniques.

### SUMMARY OF THE INVENTION

Embodiments of the present technology are directed toward stereoscopic telecommunication techniques. In one embodiment, the apparatus includes a stereoscopic camera, a pair of shutter glasses, and a processing unit communicatively coupled together. The processing unit is adapted to receive one or more images of a user's face unobscured by the shutter glasses from the stereoscopic camera during a setup phase. The processing unit is also adapted to receive images of the user wearing the pair of shutter glasses. The processing unit is adapted to replace the portion of the image of the shutter glasses in the stereoscopic image with a corresponding portion of the user's face from the image without the shutter glasses to generate a modified stereoscopic image. The modified stereoscopic image, when output on a display and viewed by another through a pair of shutter glasses, will not include the awkward and/or distracting appearance of the shutter glasses that the user is wearing.

In another embodiment, a method includes receiving sets of stereoscopic images including one or more users wearing shutter glasses, and images of the portions of the users' faces unobscured by the shutter glasses. The location of each pair of shutter glasses in the sets of stereoscopic images is determined and replaced by the corresponding portion of each user's face to generated modified set of stereoscopic images. The modified sets of stereoscopic images may then be output on a display such that the users appear as if they are not wearing shutter glasses.

In yet another embodiment, the pair of shutter glasses may alternatively include one or more cameras focused on an area of a user's face behind the pair of shutter glasses. The processing unit is adapted to receive stereoscopic images of the user wearing the pair of shutter glasses from the stereoscopic camera and an image of the area of the user's face behind the pair of shutter glasses. The processing unit is adapted to replace the portion of the image of the shutter glasses in the stereoscopic image with a corresponding portion of the user's face to generate a modified stereoscopic image. The modified stereoscopic image, when output on a display and viewed by another through a pair of shutter glasses, will not include the awkward and/or distracting appearance of the shutter glasses that the user is wearing.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 illustrates a non-auto stereoscopic display system, according to the conventional art.

FIG. 2 shows a non-auto stereoscopic teleconferencing system, in accordance with one embodiment of the present technology.

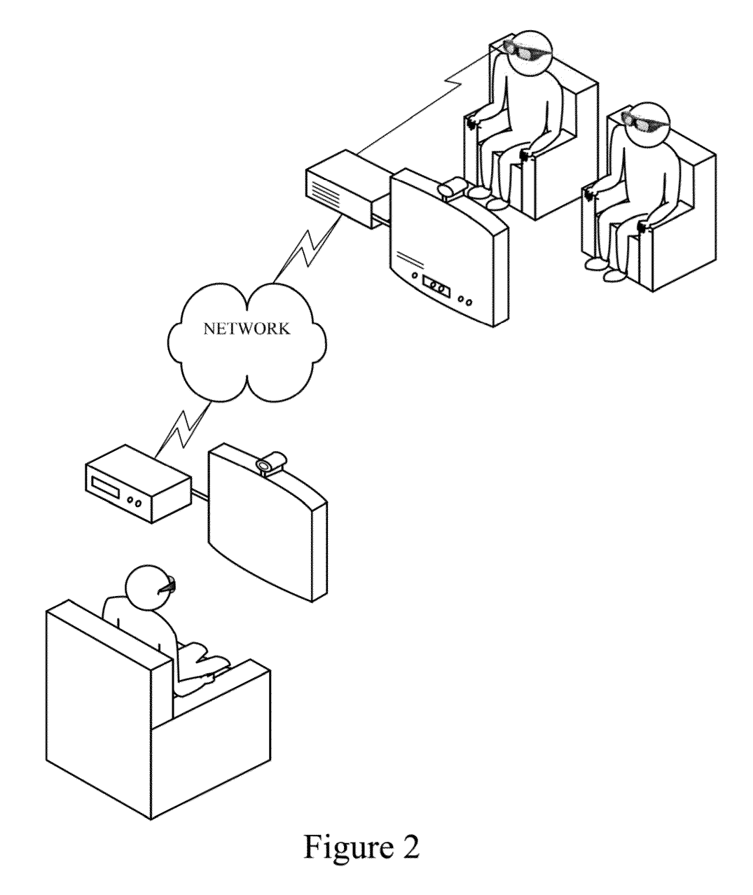

FIG. 3 illustrates a non-auto stereoscopic teleconferencing system, in accordance with one embodiment of the present technology.

FIG. 4 shows a non-auto stereoscopic teleconferencing method, in accordance with one embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that all of these terms are to be interpreted as referencing physical manipulations and quantities and are merely convenient labels and are to be interpreted further in view of terms commonly used in the art. Unless specifically stated otherwise, as apparent from the following discussion, it is understood that discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. It is also to be understood that the phraseology and terminology used herein is for the purpose of description and should not be regarded as limiting.

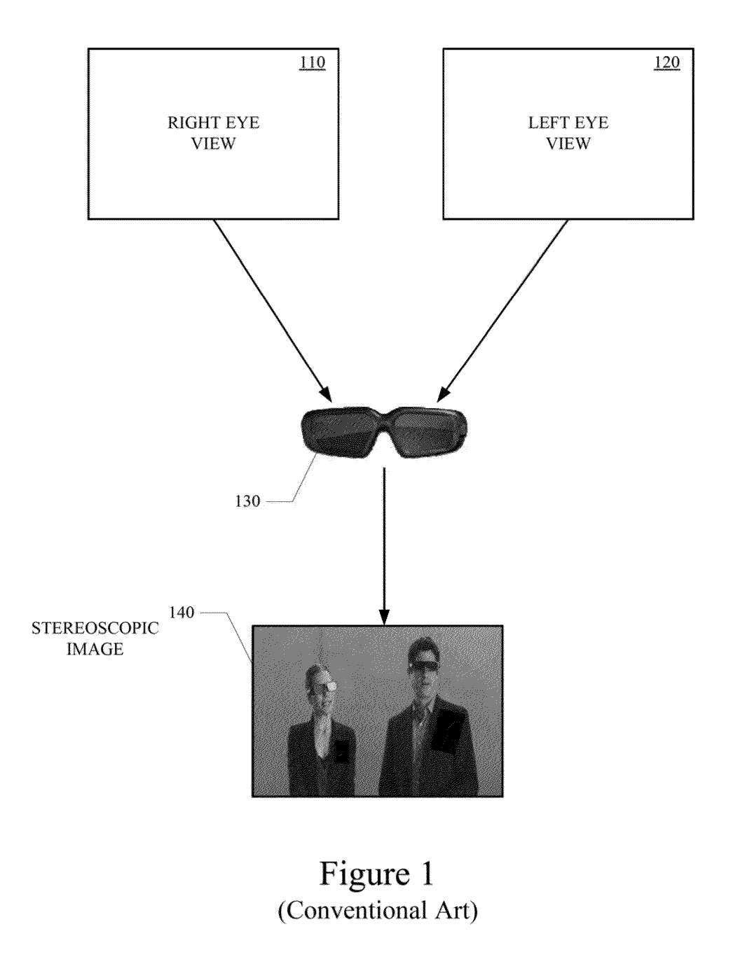

Referring to FIG. 1, a non-auto stereoscopic teleconferencing system, in accordance with one embodiment of the present technology, is shown. The teleconferencing system includes a plurality of telecommunication stations coupled by one or more networks. Each telecommunication station includes one or more displays, one or more pairs of shutter glasses, one or more stereoscopic cameras, one or more microphones (not shown), one or more speakers (not shown), and one or more processing units. Although the telecommunication stations are illustrated as including one or more separate subsystems, those skilled in the art appreciate that the subsystems may be implemented in any combination of separate and/or integral devices. For example, the display and speaker may be implemented in a first integrated device. The stereoscopic camera and the microphone may be implemented in a second integrated device separate from the display and speakers. The processing unit may be an application specific teleconferencing device, may be implemented by a general purpose computing device such as a personal computer (PC), may be implemented by a client/server computer system, or the like. However, numerous other combinations and sub-combinations are possible for implementing embodiments of the present technology.

In one implementation, the stereoscopic camera is utilized during a setup phase to capture images of the respect users' faces without the shutter glasses on. If a plurality of images are captured, the images may capture different eye positions (e.g., looking right, left, straight ahead, up and down) of the user and/or movement between different eye positions. During teleconferencing, the stereoscopic camera captures sets of left and right images at the location of the respective telecommunication station. The images generated by the stereoscopic camera during setup and the sets of left and right images generated by the stereoscopic camera during teleconferencing are transmitted to the processing unit. The processing unit uses the one or more images of a corresponding user's face captured during setup to overwrite the corresponding portion of the user's face in the sets of left and right images from the stereoscopic camera that are obscured by the shutter glasses to generate modified stereoscopic images. The processing unit may use pattern recognition to identify the location of shutter glasses in the stereoscopic images. If a plurality of images of the user's face have been captured, pattern recognition may also be used to identify the direction that the user is looking in a given set of stereoscopic images from the orientation of the users head. The processing unit uses a given image, captured during setup, having an eye position corresponding to the position of the user's head in the set of stereoscopic images to overwrite the image of the shutter glasses therein. The user in the resulting modified stereoscopic images appears to have a natural eye position. In one implementation, wire-frame modeling may be used to correlate the portion of the user's face, including the particular position of the user's eyes, for overlaying in the portion of the stereoscopic images including shutter glasses

In another implementation, the enhanced shutter glasses include one or more cameras focused on the portion of a user's face obscured by the shutter glasses. The images generated by the stereoscopic camera and the one or more cameras of the shutter glasses are transmitted to the processing unit. The processing unit uses the image of the user's face from the one or more cameras of the shutter glasses to overwrite the corresponding portions of the user's face in the image from the stereoscopic camera to generate modified stereoscopic images.

Each pair of shutter glasses may also transmit an identifying signal to the processing unit. The identifying signal may be used by the processing unit to correlate the location of the given shutter glasses and the corresponding user in the image. For example, the signal may include a unique identifier of the corresponding pair of shutter glasses and the signal may be used to triangulate the location of the shutter glasses relative to two receivers adapted to receive the identifying signal. The identifying signal is particularly useful to differentiate users and their respective shutter glasses when there are two or more users at a particular telecommunication station.

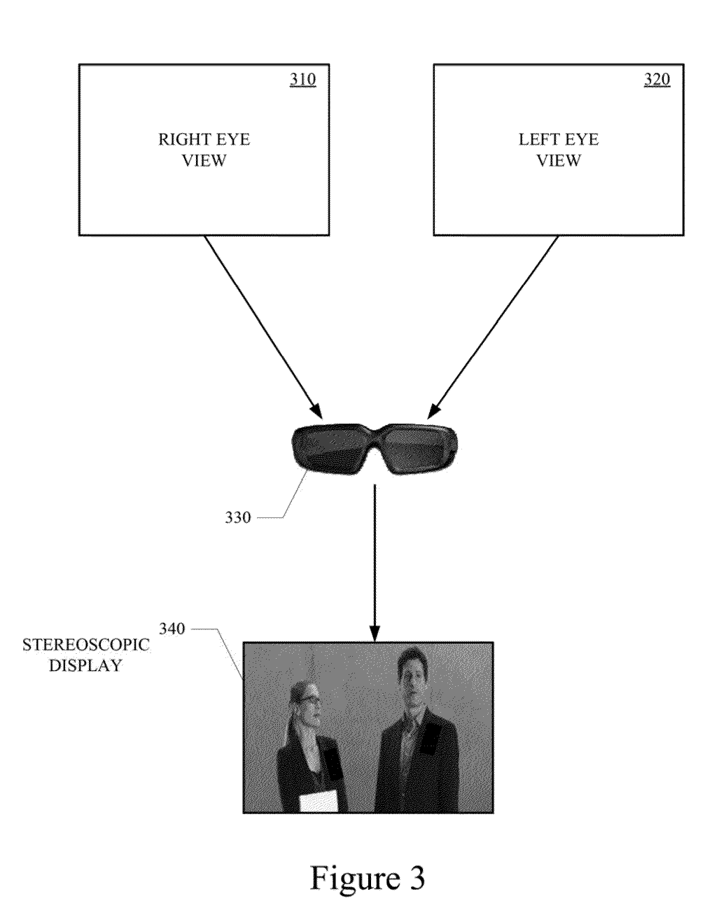

The modified stereoscopic images, wherein the users appear as if they are not wearing shutter glasses, are then transmitted by the processing unit of the corresponding telecommunication station to one or more other telecommunication stations. Each processing unit of the one or more other stations then presents the left and right eye views 310, 320 of the modified stereoscopic images on one or more displays of the corresponding telecommunication stations. Each processing unit also controls the corresponding shutter glasses 330 to synchronously turn on and off the left and right lenses to independently present the modified stereoscopic images 340 to the corresponding users at the other teleconferencing stations, as illustrated in FIG. 3. The resulting image appears to the users to have depth in front of and behind the display. In addition, the modified stereoscopic image 340, when output on a display and viewed by another through a pair of shutter glasses 330, will not include the awkward and/or distracting appearance of the shutter glasses that the user is wearing. Instead, the user will appear as if they are not wearing the shutter glasses. The modified stereoscopic image of the users without their corresponding shutter glasses may also be similarly output on the display local to the user (e.g., picture-in-picture, split screen display, or the like).

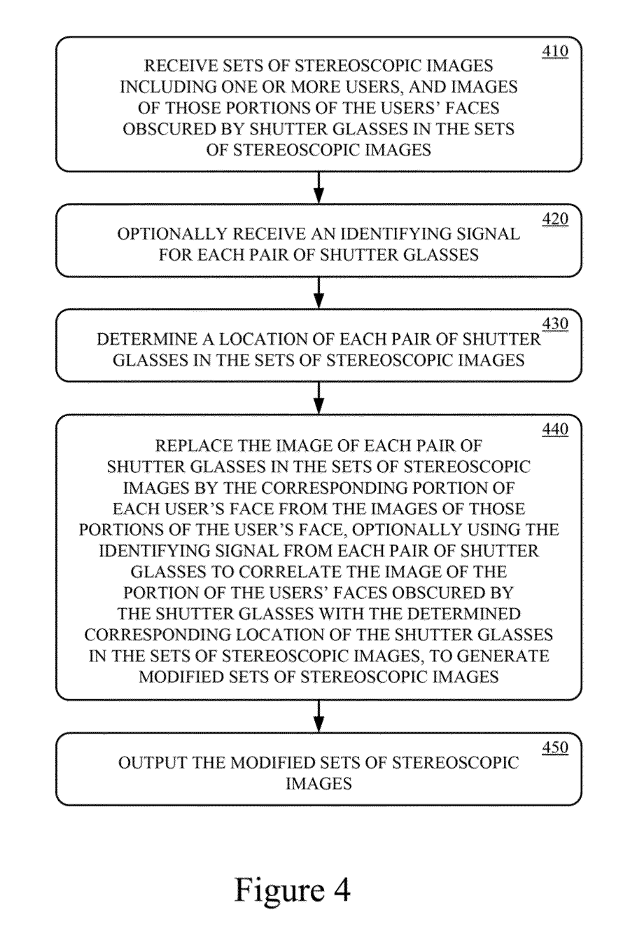

Referring now to FIG. 4, a non-auto stereoscopic teleconferencing method, in accordance with one embodiment of the present technology, is shown. The method may be implemented as computing device-executable instructions (e.g., computer program) that are stored in computing device-readable media (e.g., computer memory) and executed by a computing device (e.g., processor). In other embodiments the methods may be implemented in hardware (e.g., logic gate), or a combination of hardware and software. The method begins with receiving sets of stereoscopic images, and receiving images of those portions of users' faces obscured by shutter glasses in the stereoscopic images, at 410. In one implementation, the images of those portions of the users' faces unobscured by shutter glasses, may be received during a setup phase by the stereoscopic camera. The one or more images may include different eye positions of the users. In another implementation, the portion of the users' faces obscured by the shutter glasses is received from one or more cameras attached to the shutter glasses and aimed at the corresponding user's face. At 420, an identifying signal for each pair of shutter glasses may optionally be received. At 430, the location of each pair of shutter glasses in the set of stereoscopic images is determined. In one implementation, common anchor points are determined in the stereoscopic images and the image of the images of the user's unobscured face.

At 440, the pattern of each pair of shutter glasses in the set of stereoscopic images is replaced by the corresponding portion of each user's face to generate modified sets of stereoscopic images. In one implementation, the anchor points are used to orientate overlaying the image of the shutter glasses with the corresponding portion of the user's face. If an identifying signal for each pair of shutter glasses is received, the identifying signal may be used to correlate the image of the portion of the user's face obscured by the given shutter glasses with the determined corresponding location of the given pair of shutter glasses in the sets of stereoscopic images. At 450, the modified sets of stereoscopic images are output. For example, the modified set of stereoscopic images may be displayed on a telecommunication station local to the user and may be transmitted to other telecommunication stations for display thereon. The resulting images appear to the users to have depth in front of and behind the display. In addition, the users appear in the displayed images without their corresponding shutter glasses.

Accordingly, embodiments of the present technology improve the teleconference experience of the users. The techniques advantageously reduce the awkward and/or distracting appearance of the shutter glasses during 3D teleconferencing.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A apparatus comprising:
a stereoscopic camera;
a pair of shutter glasses; and
a processing unit, communicatively coupled to the stereoscopic camera and the pair of shutter glasses, to receive a stereoscopic image of the user wearing the pair of shutter glasses from the stereoscopic camera, to receive an image of the area of the user's face unobscured by the pair of shutter glasses, and to replace the image of the shutter glasses in the stereoscopic image with a corresponding portion of the user's face unobscured by the pair of shutter glasses to generate a modified stereoscopic image.

2. The apparatus of claim 1, further comprising a display, communicatively coupled to the processing unit, to output the modified stereoscopic image.

3. The apparatus of claim 2, further comprising a second processing unit to control a second pair of shutter glasses to present a left view image of the modified stereoscopic image to a left eye of a second user and present a right view image of the modified stereoscopic image to a right eye of the second user from the display.

4. The apparatus of claim 1, wherein the processing unit further receives an identifying signal from the pair of shutter glasses and correlates a location of the shutter glasses in the stereoscopic image to the corresponding portion of the user's face.

5. The apparatus of claim 1, wherein the image of the user's face unobscured by the pair of shutter glasses is received by the processing unit from the stereoscopic camera before the image of the user wearing the pair of shutter glasses is received from the stereoscopic camera.

6. The apparatus of claim 1, wherein the image of the user's face unobscured by the pair of shutter glasses is received by the processing unit from one or more cameras included in the shutter glasses which are focused on the area of a user's face behind the pair of shutter glasses.

7. A method comprising:
receiving sets of stereoscopic images including one or more users, and images of portions of the one or more users' faces unobscured by shutter glasses;
determining a location of each pair of shutter glasses in the sets of stereoscopic images;
replacing the image of each pair of shutter glasses in the sets of stereoscopic images by the corresponding portion of each user's face unobscured by the shutter glasses to generate modified sets of stereoscopic images; and
outputting the modified sets of stereoscopic images on a display.

8. The method according to claim 7, further comprising:
receiving an identifying signal for each pair of shutter glasses; and
replacing the image of each pair of shutter glasses in the sets of stereoscopic images using the identifying signal from each pair of shutter glasses to correlate the image of the portion of the users' faces unobscured by the shutter glasses with the determined corresponding location of the shutter glasses in the sets of stereoscopic images.

9. The method according to claim 7, wherein the image of portions of the one or more users' faces unobscured by the shutter glasses is received from one or more stereoscopic cameras during a setup phase.

10. The method according to claim 7, wherein the image of portions of the one or more users' faces unobscured by the shutter glasses is received from one or more cameras included in corresponding shutter glasses which are focused on the area of a users' faces behind the shutter glasses

11. A system comprising:
a first telecommunication station including;
a first stereoscopic camera for generating first sets of stereoscopic images;
a first pair of shutter glasses; and
a first processing unit, communicatively coupled to the first stereoscopic camera and the first pair of shutter glasses, for determining a location of the first pair of shutter glasses in the first sets of stereoscopic images and replacing the image of the pair of shutter glasses in the sets of stereoscopic images with a corresponding portion of the given user's face to generate modified first sets of stereoscopic images; and
a second telecommunication station, communicatively coupled to the first telecommunication station, including;
a first display for outputting the modified first sets of stereoscopic images;
a second pair of shutter glasses; and
a second processing unit, communicatively coupled to the display and the second pair of shutter glasses, for controlling the second pair of shutter glasses to present a left eye and a right eye view of the modified first sets of stereoscopic images output on the first display to another user.

12. The system of claim 11, wherein the first stereoscopic camera further generates one or more images of the corresponding portion of the given user's face during a setup phase.

13. The system of claim 11, wherein the first pair of shutter glasses includes a first camera for generating images of the corresponding portion of the given user's face obscured in the first sets of stereoscopic images by the first pair of shutter glasses.

14. The system of claim 11, further comprising:
the first pair of shutter glasses for outputting a signal uniquely identifying the first pair of shutter glasses; and
the first processing unit, for using the signal uniquely identifying the first pair of shutter glasses to correlate the corresponding portion of the given user's face with the determined location of the first pair of shutter glasses in the first sets of stereoscopic images.

15. The system of claim 11, further comprising:
the second telecommunication station further including;
a second stereoscopic camera for generating second sets of stereoscopic images including the other user;
the second pair of shutter glasses; and
the second processing unit for determining a location of the second pair of shutter glasses in the second sets of stereoscopic images and replacing the image of the second pair of shutter glasses in the second sets of stereoscopic images with a corresponding portion of the other user's face to generate modified second sets of stereoscopic images; and
the first telecommunication station further including;
a second display for outputting the modified second sets of stereoscopic images; and
the first processing unit for controlling the first pair of shutter glasses to present a left eye and a right eye view of the modified second sets of stereoscopic images output on the second display to the given user.

16. The system of claim 15, wherein the second stereoscopic camera further generates one or more images of the corresponding portion of the other user's face during a setup phase.

17. The system of claim 15, wherein the second pair of shutter glasses includes a second camera for generating images of the corresponding portion of the other user's face obscured in the second sets of stereoscopic images by the second pair of shutter glasses.

18. The system of claim 15, further comprising:
the second display for outputting the modified first set of stereoscopic images; and
the first processing unit for controlling the first pair of shutter glasses to also present a left eye and right eye view of the modified first sets of stereoscopic images output on the second display to the given user.
